(19) United States
(12) Patent Application Publication
(10) Pub. No.: US 2002/0174121 A1
(43) Pub. Date: Nov. 21, 2002

(54) Information management system and method

(76) Inventor: Graham Clemie, London (GB)

Correspondence Address: SALTAMAR INNOVATIONS, 30 FERN LANE, SOUTH PORTLAND, ME, 04106, US

(21) Appl. No.: 09/900,826

(22) Filed: Jul. 5, 2001

(30) Foreign Application Priority Data
May 16, 2001 (GB) 0111882.7

(51) Int. Cl. G06F 7/00

(52) U.S. Cl. 707/10

(57) ABSTRACT

Method and apparatus for implementing a computer user interface comprising of a representation of a plurality of nodes within a three dimensional space. Nodes may contain links to information sources which can be static files or information streams. User can manipulate nodes and information sources and can navigate within the three dimensional space. In one embodiment, the user interface can be applied as an alternative to conventional computer desktops.

### FIELD OF THE INVENTION

This invention relates to a user interface for displaying, organising, and interacting with information sources.

### BACKGROUND

With the growth in volume and complexity of computerised information, user interfaces for organising and displaying that information in such a way as to enable a user to navigate, work with and alter that information have become gradually more important. Perhaps the most commonly used interface at the present time is Windows® made by Microsoft, of Redmond, Wash. In particular, for complex file management the most commonly used program is Windows® Explorer, which displays a hierarchical customisable list of files on a computer. Although this program functions well, information can only be displayed in a form which represents literally the directory structure in which such data is stored and it is not readily customisable.

A primary aim of the present invention is to provide a more intuitive, customisable and readily navigable system.

U.S. Pat. Nos. 6,154,213; 6,031,537; and 6,037,944 to Natrificial® LLC describe a program known under the trade name of The Brain™ which displays a graphical representation of individual items of information and the relationships between them. One item of information (known therein as ‘a thought’) is central and other related thoughts are displayed around it depending on specified relationships. Users can navigate through such an inter-connected network of central information sources by successively selecting a new central information source. This network can also be modified by the user. Here relationships between data items can be arranged and displayed in a particular format. However, there are limits to this system. For example, individual data items can only be presented in one place in the organisation, only one static data source can be associated with a node and the structure of the organisation cannot be readily derived from another underlying data structure such as a hierarchical filing system.

Also, in The Brain™, there is no global view: a user only sees the central thought and icons representing the immediate parent, sibling and child thoughts. The Brain™ has no consistent large-scale structure but re-arranges all the thoughts around a chosen central thought, which can be disorientating.

An object of the present invention is to provide a consistent visual representation of information which a user can easily navigate.

U.S. Pat. No. 5,812,134 to Critical Thought Inc enables information in a database to be depicted as “molecules” arranged in a linear progression related to the organisational structure of the database along a thread.

U.S. Pat. No. 5,838,326 to Xerox Corporation presents a way of interactively displaying a large numbers of document objects in a three-dimensional space.

U.S. Pat. No. 5,721,900 to International Business Machines Corp provides a way of visually depicting graphical queries of the database.

The aim of the present invention is to provide an improved user interface and way of structuring and navigating data.

### BRIEF DESCRIPTION OF THE INVENTION

According to a first aspect of the present invention there is provided computer apparatus for use in accessing and organising information sources, comprising:

A module for generating a graphical output on a display, the graphical output depicting a plurality of nodes;

A module for arranging said nodes in a graphic representation three dimensional space, the location of said nodes in said three dimensional space indicating relationships between said nodes;

wherein at least one node comprises a link to an information source;

said information sources being accessible by selection of said link by user interaction with an input device.

Preferably, a relationship between two or more nodes is depicted by the relative positioning of the nodes in a representation of three dimensional space. A user viewpoint may be maintained within the space and graphical images are depicted as if the user were located at the user viewpoint within the space.

The computer apparatus typically has speakers for producing a sound depending on the location in the three dimensional space relative to the user viewpoint of nodes which link to sound information sources.

Nodes may include a link to an application and selection of the link activates the application. A user can perform actions such as creation of a link, creation of a node, moving of a link, moving of a node, altering of a node and altering of a link and can use the graphical user interface to specify the relationship between nodes.

The visual or aural appearance of a node typically depends on properties of the node or its information sources. Such properties may include: age, ownership, importance, age of node, results of a query, frequency of use, size, type, speed of link to information source, location of information source.

The appearance of a node may be altered by dynamically varying the visual or aural properties or position of the node and the same node may appear more than once within the three dimensional space. Multiple instances of the same node may be highlighted in response to selection of a node.

The nodes may be prepared from a hierarchical filing system.

The interface may automatically link information to nodes, when the information is received, sent or newly created. Optionally, a new node may be created upon receiving, sending or creating information. The information may be received, sent or newly created in the form of a message such as an e-mail message.

An information source may further include a link to information concerning the node itself.

According to a second aspect of the present invention there is provided a method of controlling a graphical user interface comprising the steps of:

maintaining a database of nodes and relationships between said nodes, wherein at least one node comprises a link to an information source;

creating a data structure comprising a model of said nodes arranged in a three dimensional space in a manner depending on the relationship between said nodes; and

causing a graphic display program to prepare a visual display corresponding to said data structure.

According to a third aspect of the present invention there is provided a computer program comprising program instructions which, when loaded into a computer, will cause it to perform as the computer apparatus of the first aspect.

According to a fourth aspect of the present invention there is provided a computer program comprising program instructions which, when loaded into a computer, will cause it to carry out the method of the second aspect.

According to a fifth aspect of the present invention there is provided a computer readable media comprising the computer program of the third aspect.

According to a sixth aspect of the present invention there is provided a computer readable media comprising the computer program of the fourth aspect.

### DESCRIPTION OF THE DRAWINGS

An example embodiment of the present invention will now be illustrated with reference to the following Figures in which:

FIG. 1 is a figurative drawing of a computer suitable for implementing the invention;

FIG. 2 is a schematic representation of a node;

FIG. 3 is a schematic representation of a galaxy of nodes;

FIG. 4 is a perspective representation of a universe comprising of four galaxies;

FIG. 5 is a flow chart of a method for preparing a visual representation of a universe of nodes; and

FIG. 6 illustrates a data structure for storing information about a universe of nodes.

### DETAILED DESCRIPTION OF THE INVENTION

The present invention is a computer-based user interface for displaying a three-dimensional representation of information sources. The invention also relates to methods of navigating through the displayed information, adding information to the database and working with underlying information sources.

In this specification and the appended; claims, the term “information source” relates to any electronically stored data such as documents, databases, applications, pointers to other data such as addresses of files or hyperlinks, information streams such as sound or video which may or may not be pre-recorded, and any other source of data. Information streams, such as video, may be provided in an analogue state or read in an analogue format and digitised as and if required.

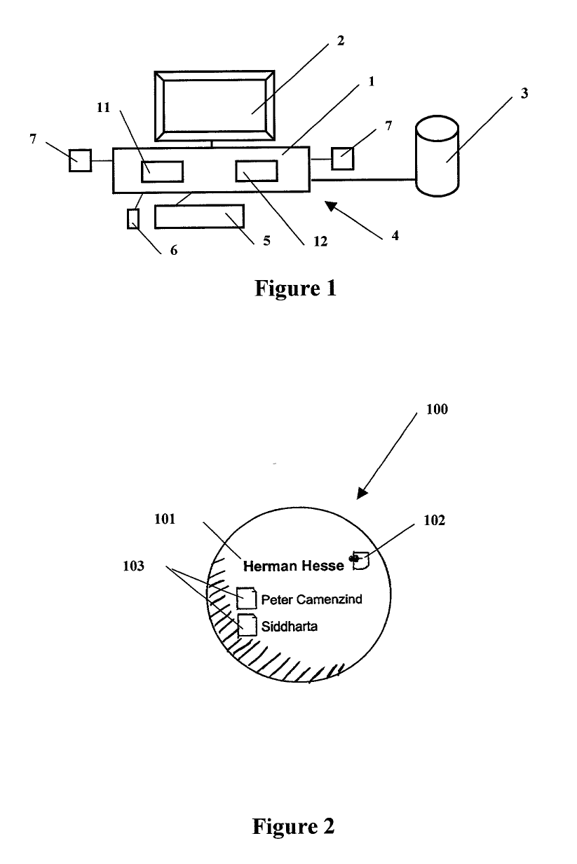

FIG. 1 illustrates a computer in which the software herein disclosed can be executed. The computer 1 comprises at least one microprocessor, storage, an interface generating module 11 and a node arrangement software module 12. The computer has a display such a monitor 2 and access to a database 3 of information sources. Although the database 3 of information sources is shown external to the computer 1 in FIG. 1, it will most typically be an internal memory storage device such as a hard drive.

Information sources might be derived from more than one database and information might also be included from information streams 4 such as audio or video stream information from a file, a peripheral such as CD ROM or an external source, for example, the Internet.

Input devices such as a keyboard 5 and mouse 6 are also provided. In the present invention, information sources are treated as objects and displayed in a three-dimensional space, within which they can be arranged and interacted with. Further information sources can be categorised, added and related to other information sources through manipulation of the objects within the three-dimensional space. A sound generation module 7 is provided for producing a sound depending on the location in the three dimensional space relative to the user viewpoint of nodes which link to sound information sources.

FIG. 2 shows a node which is a unit of categorised information in the user interface of the present invention. A node 100, has a title 101 and nil or one information sources 102 containing notes pertaining to the node or its contents which can be accessed by clicking on the visible link. It also contains nil, one or more than one associated information sources 103 which can be accessed by clicking on the visible links. Links are usually icons; other possibilities include text, such as the title of the information source. Most nodes have information sources associated with them; here, these are documents labelled ‘Peter Camenzind’ and ‘Siddharta’.

Nodes, according to the present invention, are related to but different from either folders in standard hierarchical filing system or thoughts in The Brain™ as typified in U.S. Pat. Nos. 6,037,944 and 6,031,537. Folders in hierarchical filing systems such as Unix, DOS or Microsoft® Windows® can contain multiple files and other folders. They can have names and some limited selection of other properties applied to them. However, they cannot contain information streams and they are strictly hierarchical, other than where alias or shortcuts are used to link folders to different places. In The Brain™ each thought can contain at most a single file. This can not be an information stream and the thought only appears once in the network of thoughts at the same time.

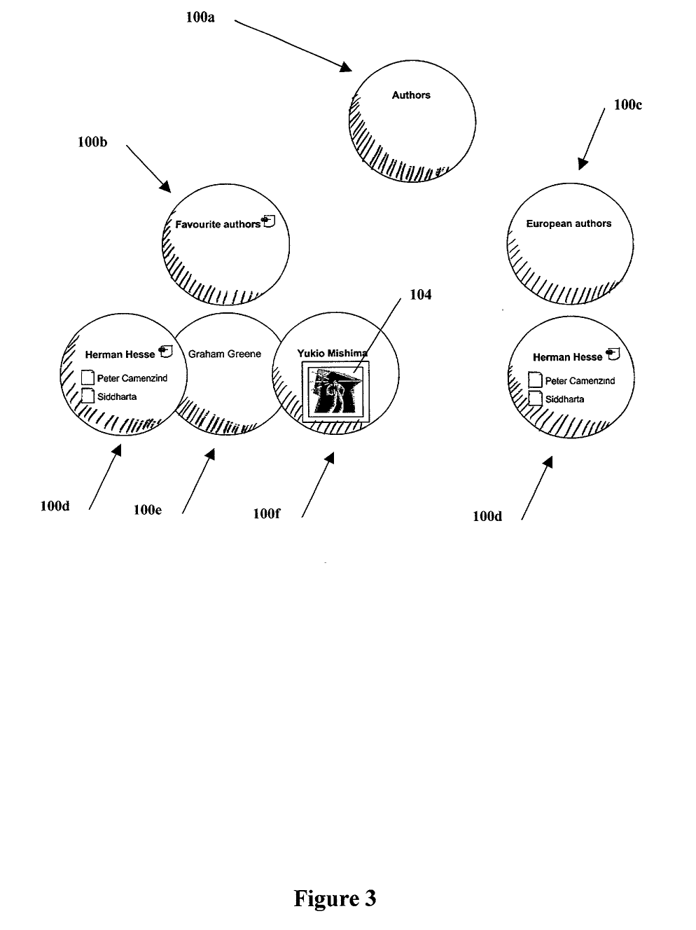

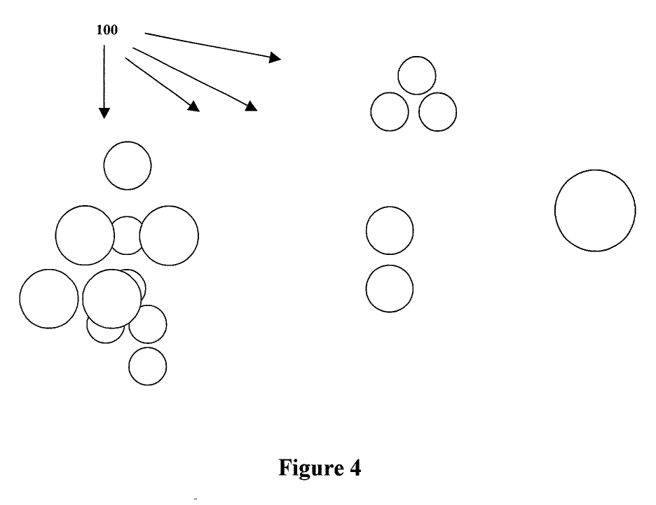

FIG. 3 shows a collection of nodes known herein as a galaxy of nodes, as displayed on screen. Nodes in a galaxy are connected directly or indirectly by links or associations. More than one galaxy can be contained in the same overall representation, referred to as a universe. Galaxies are separate if there is no link or association between them. The galaxy of nodes will be displayed three-dimensionally and the relative positioning of the nodes indicates associations between them. For example, in FIG. 3, node 100a ‘Authors’ is associated with ‘Favourite Authors’ 100b and ‘European Authors’ 100c. The relative positioning of nodes is discussed further below. It will be seen that there is a three dimensional character to the network as is shown by the positioning of 100e behind 100d and 100f from the particular camera angle. For the purpose of illustration, FIG. 4 shows a universe comprising of four galaxies where all nodes are the same radius and so their apparent relative size illustrates their distance from the observer. Preferably, nodes can be any size, and may differ in size according to the number of information sources they contain.

Associations have an hierarchical sense in which ‘child’ nodes are linked to ‘parent’ nodes which are generally fewer in number and often relate to more general concepts. However, there are important differences between the parent-child relationships displayed in the present invention from the simple hierarchical folder structure of operating systems such as DOS 6.1, MacOS and Unix.

In FIG. 3, node 100d appears twice in the arrangement: the node entitled ‘Herman Hesse’ is contained both in favourite Authors and European Authors. Changes to underlying information sources grouped within each node, thereby affect both nodes.

As well as conventional static files, information sources may also be streamed information which can be output continuously through the user interface, for example, a video clip 104 or sound clips. Information streams can be live or pre-recorded and they can be played in a window on a computer screen or over speakers for an audio stream instead of simply listing them with a static descriptor. For example, web pages, video/audio or dynamically changing text such as stock prices, can be readily displayed using conventional software techniques well-known in the art to display an information stream in a specified area of a screen.

### Preparation of a User Interface

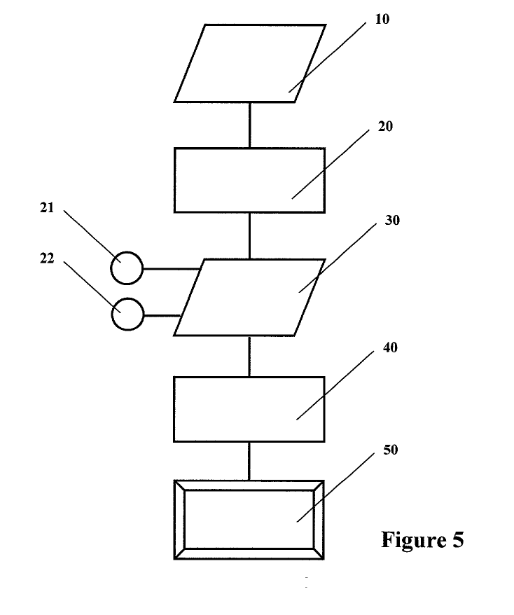

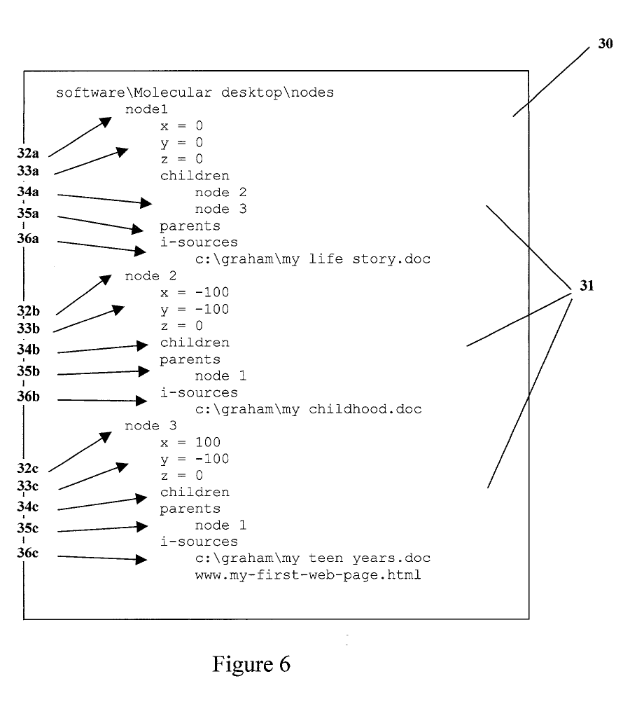

FIG. 5 illustrates the process by which a universe of nodes is displayed on a screen or output through other peripherals such as loudspeakers. Information concerning the nodes, the relationship between nodes and information sources associated with such nodes is stored data 10. This is processed 20 to produce a spatial arrangement data file 30, for example, by parsing the list of nodes 10 and calculating co-ordinates associated with them. Different graphical representations of the hierarchical structure may be prepared in response to the value of a parameter 21. A parameter 22 which comprises information relating to the user viewpoint within the three dimensional space may be used to prepare the graphical representation according to the user viewpoint. The underlying logic and connections between the nodes can therefore be readily represented in different ways by processing data according to this method. Typically, relationships between nodes are indicated by the relative position of nodes to each other.

### Example Galaxy Structure

FIG. 3 illustrates an example representation in which a hierarchy of nodes is implied by presenting a top level (100a), a mid level (100b and 100c) and a lowest level (100d,100e,100f) on successive spaced planes. Grouping between nodes is represented by presenting related low level nodes, e.g. 100d, 100e, 100f close together and close to their parent node 100b. Mid level nodes 100b and 100c are spaced out, on the same plane, to allow the lowest level nodes to be displayed clearly, but when viewed on a large scale they are still close to their mutual parent node 100a. As many or few successive levels may be provided as is required and planes need not be flat; for example, they may be spherical shells.

In an alternative representation, the graphical arrangement of nodes is analogous to a solar system with a central ‘sun’ node and child nodes displayed as planets. This can then be displayed within ‘galaxies’ within a ‘universe’ model.

In another alternative, each node is displayed in a format designed to look like atoms in standard representation of a molecule. Nodes are positioned around a circle (the diameter of which may be adapted depending on the number of parent-child relationships relating to that node) and their positions may be altered to avoid obscuring important features. When there are too many nodes to fit in a single circle, a further circle of greater radius is provided. Each time a node is added to or removed from the arrangement, the entire structure may be recalculated, checking no parts overlap using known collision detection algorithms.

The separation of the prepared position data file 30 from the underlying stored data 10 in response to a parameter 21 allows the display to be readily adapted without changing the underlying parent-child relationships.

### Data Structure

FIG. 6 shows the prepared data 30. Individual nodes are represented by data structures 31. Each of the titles associated with it 32a, 32b, 32c and the co-ordinates 33a, 33b, 33c associated with the node in the particular graphical representation dictated by parameter 21. A list of children nodes 34a, 34b, 34c is provided. Notice that similarly parent nodes, being nodes higher up in a pseudo-hierarchical structure, 35a, 35b, 35c are also listed. Notice that 34a has two children, whereas 34b and 34c do not. Any number of children and parents can be used.

A list of files or information sources 36a, 36b and 36c is provided. There can be no information sources, only one information source 36a, 36b or multiple information sources 36c. Data structure 30 could store all the information of a particular information source. However, more likely, it would be a pointer to the information such as the address, a location in a filing system or other pointer to an information source.

Notes 102 relating to a node rather than to a particular information source can also be provided, for instance in the form of an icon which displays the notes when selected.

### Presentation of User Interface

Importantly, the invention does not concern itself with the mechanics of actually graphically displaying the underlying universe of nodes and merely goes as far as calculating a spatial arrangement data file 30 and how these relate to information sources.

Graphical processing software 40 to provide a visually displayed image 50 can therefore be adapted to the particular hardware upon which the machine is running. Typically, when software is implemented on a PC, Microsoft® DirectX® Technology provides a useful interface for displaying graphics adapted to a particular graphics accelerator in a particular PC. This software calculates the effects of perspective and other visual properties and prepares an image from the underlying data. Another technology would be Open GL. Essentially the third party graphic display software 40 which requires only the X, Y, Z co-ordinates and other parameters of objects to be displayed and can adapt to produce a two-dimensional representation on screen of the underlying three-dimensional structure. This modular nature makes it readily adaptable so, for example, it is possible to introduce a system which outputs the data in true 3D form for the user to view with 3D glasses such as shutterglasses, for example, Sony® Glastron® or anaglyph imaging techniques.

It is possible to maintain the co-ordinates of a viewpoint and camera angle of a user within the three-dimensional universe of nodes. Additionally, a camera angle and scaling factor can be stored and used by graphical processing software to produce an image corresponding to a particular viewpoint by standard image processing techniques.

This allows additional effects to be created. For example, a soundscape can be created in which as the co-ordinates of the user's viewpoint move around different nodes, sounds are produced which simulate the sounds the user would hear, were each source of sound taking place at the location in three-dimensional space of that node and were the user at the specified viewpoint in three-dimensional space. Sounds from individual nodes are attenuated according to their distance from the user's simulated position and/or the screen. Different sounds may attenuate differently to improve perception of specified sounds. Different audio streams from information sources associated with nodes can be combined with their volume being in proportion to the distance between the viewpoint and the node in three-dimensional space. Other mathematical relations between sound volume and distance, such as an inverse square of distance relationship, may be used and the precise mathematical relation can be adapted to the particular application. A three-dimensional audio system can be used in conjunction with this invention so as to further improve the user interface.

### User Interaction with User Interface

The viewer can rotate and zoom in and out of the universe of nodes so as to get a better overview of the totality of information and the inter-relationships between individual items. This manipulation aids the user in accessing a cluster or single item of information. Movement of the user can be implemented by updating their position co-ordinates, camera angle and the like by methods well known in the field of computer aided design and simulators and then refreshing the screen display.

Movement of the user through the simulated space can be implemented by a number of means known in the field of computer simulation. In one example suitable for use with a conventional PC keyboard, pressing the left mouse button whilst holding the shift key zooms in and the right button zooms out. Equally, moving the mouse whilst holding the shift key down will move the whole structure in the opposite direction of the mouse movement. Moving the mouse without the shift key down holds the structure in place but allows the mouse to roam over it. Any time the mouse moves over a node causes all instances of that node in the universe to flash.

Individual nodes can be moved, arranged, cut and pasted within three-dimensional space. Adding/removing/moving nodes and their children can be achieved by right clicking on a node which brings up a menu from which the various commands can be triggered. Nodes can be selected by left-clicking, cut by either CTRL-X or by bringing up a menu by right clicking on the node and then choosing cut. To paste as a child of another node either select the new parent and press CTRL-V or choose from the right button menu. To create a new galaxy then select ‘space’ and then do the same.

All the sub-structure below a chosen node will automatically be moved/copied/pasted accordingly. In such a case the x,y coordinates will be where the mouse is and the z coordinate will be a pre-set distance from the screen.

Interaction with the graphical user interface allows interaction with underlying information sources. For example, one can select a document, edit the document and therefore change the actual document itself by calling an executable editing program associated with the document type as is well known in contemporary operating systems.

### Use of System as Computer Desktop Interface

In one embodiment, the system can be used as the heart of a three-dimensional equivalent of a standard computer desktop. A computer desktop is a graphical representation on a computer display of a work environment. In this embodiment, the system becomes the computer's primary user interface for accessing files and applications.

Selecting an information source opens the corresponding information source for viewing or editing. For example, selecting an information source which corresponded to a word processing document would cause the corresponding word processor program to open up, editing the word processing document, analogously to the response of Unix, Windows®, MacOS® and other operating systems known at the present time to selection of a document associated with an application.

Executable programs can also be represented as information sources and executed when icons corresponding to them are selected by the user of the interface.

### Creating a Universe of Nodes From an Existing Filing System or Database

Although a universe of nodes can be user designed, a universe of nodes can also be created from an existing file hierarchy or database. For example, an hierarchical filing system can be searched electronically and nodes created equivalent to folders within that hierarchical filing system. Parent - child relationships are set up between folders and sub-folders. Files within particular folders become information sources 103 within the node corresponding to the particular folder.

The system may have predefined, inputted or learned rules on how to arrange newly created, received or sent information sources. The way in which they treat data may depend on whether the information sources are created by third parties—e.g. stored on shared storage—or by the primary user of the system. The system may establish where to file a newly created information source by context, for example, attaching replies to an e-mail to the same or a related node. Suffixes, such as the three letter suffixes used in DOS and Windows® or file creator info might be used to help index files. Individual information sources can be scanned and information found therein can be used to file the information source.

### Filing E-mail

For example, when the new e-mail is created, the subject can be registered with a node and when the e-mail is sent that e-mail and any attachments or any information sources relating to it are stored in that node, along with any other information sources which are already there. Furthermore, when an incoming e-mail arrives relating to that subject area it could be stored in the relevant node. The system can be adapted so that when an e-mail is dragged and dropped into a node its subject or address or other parameters selected by the user are automatically registered and any other e-mails related to that are automatically stored in that node. Again, the fact that an information source may be depicted in a plurality of nodes makes it particularly easy to later establish relevant information. This automatic filing can readily be applied to other types of messages such as faxes and SMS text messages or any type of information sources, received, sent or created, such as input data streams, newly downloaded files etc.

### Alternative Software Configuration

In an alternative software architecture, four distinct types of software component are provided, together implementing the system. A first software component functions as graphic processing module 40 and prepares the graphic interface. For example, using VRML (virtual reality markup language), Java3D or Macromedia® Shockwave®. These may use DirectX® or OpenGL® to interface with graphics hardware. A second software component underneath the first component interfaces with information sources and calculates the location in three-dimensional space of the nodes, altering this in response to user interaction. A third type of plug-in software component acts as an interface with individual information source types. For example, a plug-in can be provided to interface with a conventional operating system hierarchical filing system enabling the system to be used as a computer desktop, another might interface with internet or intranet published information.

Finally, a fourth software component enables a user to publish information sources on their computer or database, presenting them to remote computers and setting access rights. The software components may be standalone applications or may function within a web browser. In one embodiment, third and fourth software components receive and share information sources in XML, allowing the documents to be transmitted using known internet/intranet web sharing technology.

### Additional Features

Other attributes of the node can be made apparent by changing one of its physical features such as the colour or size of the node. This can be done to display ownership, importance, age of a node or other properties. Some attributes can be properties such as ageing, which may be calculated automatically each time a universe of nodes is displayed. All manner of attributes may be reflected in the visual appearance of a node. Some of these attributes relate to the node and some to properties of one or more information sources within that node. Example attributes of nodes or their information sources are: age, size, ownership, type, frequency of use, speed of link to information source (e.g. speed of internet connection for internet provided information stream), relevance to the results of a search, location etc.

Nodes can appear in multiple places at the same time. An information source may also appear in different nodes at the same-time. The invention therefore acts like a relational database. In practice, there will preferably be only one copy of the underlying data or the underlying node in memory, but visually the node can be displayed more than once according to its relationship with other nodes.

There are two possible ways in which this can be carried out. Either two logically separate nodes with identical information sources associated with them can be stored in memory or, alternatively, a single node can have more than one set of co-ordinates and more than one set of parent/child relationships. The latter case is preferred.

As an additional feature, selecting an individual node or information source calls all instances of that particular object to change a physical attribute, for example by flashing or moving.

A user may be given, in response to their selection or otherwise, a selective view of the universe of nodes according to any criteria they select, for example, access rights, document ownership or authorship, type of document or information source. This could involve rearranging the universe of nodes but, preferably, nodes fulfilling the criteria are highlighted in another way—for example, all other nodes are dimmed to highlight the selected nodes or replaced with placeholders.

In a multi-user version of the invention, whenever new nodes or information sources are added, other users are alerted to the fact and a new item can be highlighted by changing a physical attribute such as the colour of the node. This can be changed for a period of time and could appear different to different users. In one embodiment, the underlying data 10 is shared but each user has a separate spatial arrangement data file 30 and navigates separately through the simulated three dimensional space. In another embodiment the same coordinate information from the spatial arrangement data file 30 is the basis for the display presented to each user; however, this data file is customised, e.g. by altering the visual properties of nodes, to provide a customised view to each user, reflecting their own preferences and attributes particular to that user, such as access rights.

The user can alter the distance between nodes and filter out particular nodes eg by darkening them or cutting them out so as to increase visibility. This may be carried out automatically by calculating whether some nodes are likely to be blocking the view. For example, nodes very close to the viewpoint of the user might be omitted.

An additional module may be provided to store the co-ordinates of the nodes and re-load them when required, reducing the need to fully recalculate the spatial arrangement data file 30 each time the system is booted up.

An additional software module can manipulate the molecule and the most frequently used modes can be made more accessible through the position of jump buttons on screen which, when selected, cause the user to move to a viewpoint close to that particular frequently used node. Alternatively, the graphical or audio attributes of the most frequently used nodes can be altered. For example, they may be easily displayed as glowing as if to represent friction from having been used in a manner allied to that disclosed in U.S. Pat. No. 5,684,969. The most frequently used nodes can be calculated either by tracking the number of times a node is selected by the user, or by calculating the amount of time that the node spends being close to the viewpoint of the user.

Nodes may be automatically animated. For example, they can rotate about one more of their axis. The distance between them can increase and decrease periodically. As well as purely visual effects, this will enable the user to more readily browse the overall structure without having nodes fixed in locations where they obscure others permanently.

This can be achieved by altering the information 30 fed to the graphics engine 40.

Some nodes can be represented as translucent. In a typical graphical representation, the user is considered as having a viewpoint which is a location within the same three-dimensional simulated space in which the nodes are modelled. It is a standard procedure to calculate a visual rendering of the scene from the co-ordinates of the objects to be displayed and the co-ordinates and camera angle of the user. It is also well known for the user by interacting with peripherals 5, 6, to manoeuvre the viewpoint and camera angle through a simulated three-dimensional space.

Alterations to the displayed properties of nodes (e.g. colour, glowing, opacity, movement) can be implemented either by a software module altering the spatial arrangement data file 30 between successive display updates or by passing parameters to the graphic engine 40. For example, many known graphic rendering tools allow opacity to be set as a parameter.

Although the embodiments described herein and with reference to the drawings comprise computer programs and processes performed in computer apparatus, the invention also extends to computer programs, particular programs on or in a carrier, adapted for putting the invention into practice. The program may be the form of source code, object code, a code intermediate source and object code in a partially compiled form, or in any other form suitable for the implementation of the processes and apparatus according to the invention. The carrier may be any entity or device capable of carrying the program.

For example, the carrier may comprise a storage medium, such as a ROM, for example a CD-ROM or semiconductor ROM, or a magnetic recording medium, for example a floppy disk or hard disk. Further, the carrier may be a transmissible carrier such as an electrical or optical signal which may be conveyed via electrical or optical cable or by radio or other means. When the program is embodied in a signal which may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant processes.

Further alterations and modifications can be made within the scope of the invention herein disclosed.

1. Computer apparatus for use in accessing and organising information sources, comprising:
an interface generating module having a graphical user interface functionality adapted for generating a graphical output on a display, the graphical output depicting a plurality of nodes;
a node arrangement software module responsive to information reflecting the relationship between said nodes adapted for arranging said nodes in a graphic representation of three dimensional space, the location of said nodes in said three dimensional space indicating relationships therebetween;
wherein at least one node comprises a link to an information source;
said information source being accessible by selection of said link responsive to user interaction with an input device.

2. The computer apparatus of claim 1 wherein a relationship between at least two nodes is depicted by the relative positioning of the nodes.

3. The computer apparatus of claim 1 wherein the interface generating module is adapted for displaying a representation of a three dimensional space comprising nodes having three dimensional co-ordinates associated therewith.

4. The computer apparatus of claim 3 which maintains a user viewpoint within the three dimensional space and calculates graphical images as if the user were located at the user viewpoint within the three dimensional space.

5. The computer apparatus of claim 3 further comprising a sound generation module, the sound generation module producing a sound depending on the location in the three dimensional space relative to the user viewpoint of nodes which link to sound information sources.

6. The computer apparatus of claim 1 wherein at least one node comprises a link to an application and selection of said link activates said application.

7. The computer apparatus of claim 1 comprising user interface software module having a graphical user interface functionality adapted for enabling a user to perform an action selected from the list consisting of: creation of a link, creation of a node, moving of a link, moving of a node, altering of a node and altering of a link.

8. The computer apparatus of claim 1 comprising user interface software module having a graphical user interface functionality adapted for specifying the relationship between nodes.

9. The computer apparatus of claim 1 wherein the visual or aural appearance of a node reflects properties of the node or its information sources.

10. The computer apparatus of claim 9 wherein the properties of the node or its information sources are selected from a list consisting of: age, ownership, importance, age of node, results of a query, frequency of use, size, type, speed of link to information source, location of information source.

11. The computer apparatus of claim 1 wherein the appearance of a node is altered by dynamically varying the visual or aural properties or position of the node.

12. The computer apparatus of claim 1 wherein the same node or information source appears more than once within the three dimensional space.

13. The computer apparatus of claim 1 adapted to highlight multiple instances of the same node or information source in response to selection of a node.

14. The computer apparatus of claim 1 adapted to prepare a plurality of nodes from a hierarchical filing system.

15. The computer apparatus of claim 1 adapted to automatically link information received, sent or newly created to a node.

16. The computer apparatus of claim 15 wherein a new node is created upon receiving, sending or creating information.

17. The computer apparatus of claim 15 wherein information is received, sent or newly created in the form of a message.

18. The computer apparatus of claim 17 wherein said message is an e-mail message.

19. The computer apparatus of claim 1 wherein at least one information source further comprises information concerning the node.

20. The computer apparatus of claim 1 wherein the graphical user interface functions as a computer desktop.

21. A method of controlling a graphical user interface comprising the steps of:
maintaining a database of nodes and relationships between said nodes, wherein at least one node comprises a link to an information source;
creating a data structure comprising a model of said nodes arranged in three dimensional space in a manner depending on the relationship between said nodes; and
causing a graphic display program to prepare a visual display corresponding to said data structure.

22. The method of claim 21 wherein a relationship between at least two nodes is depicted by the relative positioning of the nodes.

23. The method of claim 21 wherein the graphic display program displays a representation of a three dimensional space with reference to three dimensional co-ordinates associated with each node.

24. The method of claim 23 further comprising the step of maintaining a user viewpoint within the three dimensional space and calculating graphical images as if the user were located at the user viewpoint within the three dimensional space.

25. The method of claim 23 further comprising the step of generating sound using a sound generation module, wherein the sound generated depends on the location in the three dimensional space relative to the user viewpoint of nodes which link to sound information sources.

26. The method of claim 21 wherein one or more nodes comprise a link to an application and selection of said link activates said application.

27. The method of claim 21 wherein a user can perform an action by use of a user interface, the action being selected from the list consisting of: creation of a link, creation of a node, moving of a link, moving of a node, altering of a node and altering of a link.

28. The method of claim 21 wherein user interface may be used to specify the relationship between nodes.

29. The method of claim 21 wherein the visual or aural appearance of a node depends on properties of the node or information sources.

30. The method of claim 29 wherein the properties of the node or its information sources are selected from a list consisting of: age, ownership, importance, age of node, results of a query, frequency of use, size, type, speed of link to information source, location of information source.

31. The method of claim 21 wherein the visual appearance of a node is altered by dynamically varying the visual or aural properties or position of the node.

32. The method of claim 21 wherein the same node or information source appears more than once within the three dimensional space.

33. The method of claim 21 further comprising the step of highlighting multiple instances of the same node or information source in response to selection of a node.

34. The method of claim 21 further comprising the step of preparing a plurality of nodes from a hierarchical filing system.

35. The method of claim 21 further comprising the step of automatically linking information received, sent or newly created to a node.

36. The method of claim 35 wherein a new node is created upon receiving, sending or creating information.

37. The method of claim 35 wherein information is received, sent or newly created in the form of a message.

38. The method of claim 37 wherein a message is an e-mail.

39. The method of claim 21 wherein at least one information source further comprises information concerning the node.

40. The method of claim 21 wherein the graphical user interface functions as a computer desktop.

41. A computer program comprising program instructions which, when loaded into a computer, will cause it to perform as the computer apparatus of claim 1.

42. A computer program comprising program instructions which, when loaded into a computer, will cause it to carry out the method of claim 21.

43. A computer readable media comprising the computer program of claim 41.

44. A computer readable media comprising the computer program of claim 42.

45. Computer apparatus for use in accessing and organising information sources, comprising:
means for generating a graphical output on a display, the graphical output depicting a plurality of nodes;
means for arranging said nodes in a graphic representation of three dimensional space, the location of said nodes in said three dimensional space indicating relationships between said nodes;
wherein at least one node comprises a link to an information source;
said information source being accessible by selection of said link responsive to user interaction with an input device.
